(19) United States
(12) Patent Application Publication
(10) Pub. No.: US 2010/0199921 A1
(43) Pub. Date: Aug. 12, 2010

(54) MULTI-NEED CAT ACTIVITY PAD

(75) Inventors: David Haaf, San Rafael, CA (US); Betty Lee, San Rafael, CA (US)

Correspondence Address: Bay Area Technolgy Law Group PC, 500 Sansome Street, Suite 404, San Francisco, CA, 94111, US

(73) Assignee: Worldwise Inc., San Rafael, CA (US)

(21) Appl. No.: 12/368,483

(22) Filed: Feb. 10, 2009

(51) Int. Cl. A01K 15/02; A01K 29/00

(52) U.S. Cl. 119/706; 119/702; 119/707; 119/708

(57) ABSTRACT

A cat activity pad sized to accommodate a domestic cat. The pad is characterized as having a plurality of distinct regions, each region designed to satisfy a need of a domestic cat different from at least one other region. As a preferred embodiment, loops are releasably retained by the cat activity pad extending over the pad to hang pet toys thereon.

### TECHNICAL FIELD

A cat activity pad sized to accommodate a domestic cat. The pad is characterized as having a plurality of distinct regions, each region designed to satisfy a need of a domestic cat different from at least one other legion. As a preferred embodiment, loops are releasably retained by the cat activity pad extending over the pad to hang pet toys thereon.

### BACKGROUND OF THE INVENTION

The pet toy market is large and growing as pet owners seek creative ways to stimulate their pets and to provide tools for self entertainment, particularly when the pet is alone for extended periods of time. Within this category are items which are intended to be used by domestic cats recognizing that they have certain needs which are not shared by other domesticated animals.

Cats, more than any other domestic pet, require stimulation and nurturing. Thus, cats are usually provided with scratching surfaces recognizing the inherent need of a cat to scratch as well as hanging toys which could be swatted to, again, stimulate the cat and provide self entertainment.

Although there are cat-related products which individually can be used to satisfy their needs, it has not heretofore been a priority of the pet industry to combine somewhat unrelated products in order to centralize a number of such needs. In doing so, one is able to avoid a scattering of pet products and can, by contrast, neatly segregate such products in a single location. When in the form of an activity pad, when not in use, the product can simply be rolled or folded into a compact package for storage. Likewise, during transportation and sales, such a product can occupy a relatively small volume thus reducing shipping costs and costly shelf space which, oftentimes, must be purchased by a supplier as required by the retail merchant.

### SUMMARY OF THE INVENTION

A cat activity pad sized to accommodate a domestic cat. The pad is characterized as having a plurality of distinct legions, each region designed to satisfy a need of a domestic cat different from at least one other region. As a preferred embodiment, loops are releasably retained by the cat activity pad extending over the pad to hang pet toys thereon.

### BRIEF DESCRIPTION OF THE FIGURES

FIG. 1 is a perspective view of the cat activity pad of the present invention.

FIG. 2 is a cross-sectional view of the cat activity pad of FIG. 1 taken along lines 2-2.

FIG. 3 is a perspective view of a second embodiment of the present cat activity pad.

FIGS. 4 and 5 are perspective views of the present cat activity pad having retained loops for hanging cat attractant toys.

### DETAILED DESCRIPTION OF THE INVENTION

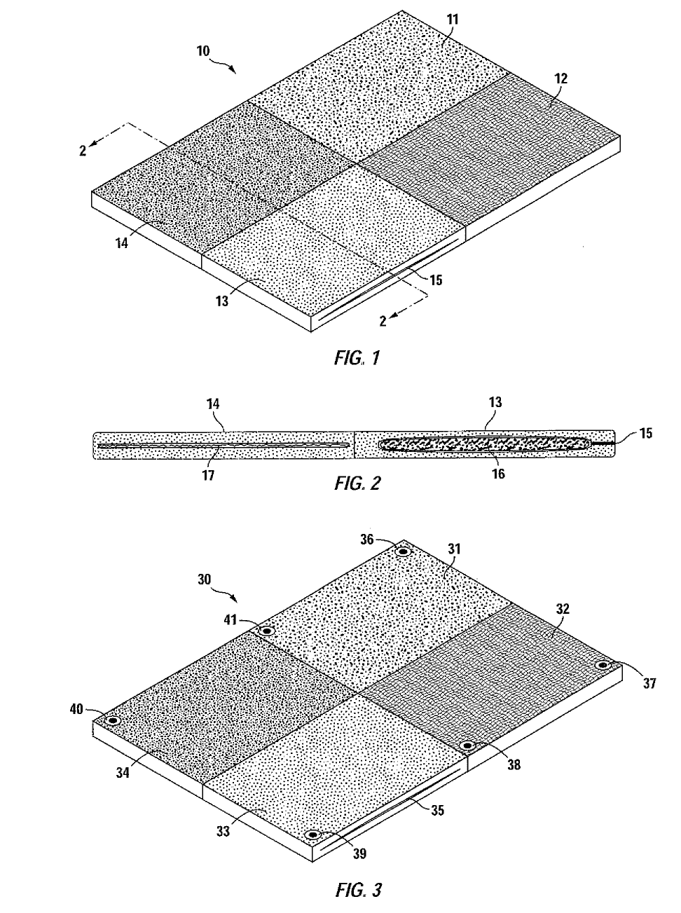

Turning first to FIG. 1, the present invention involves a pet activity pad 10 sized to accommodate a domestic cat. Pad 10 comprises a plurality of distinct regions 11, 12, 13 and 14, each region designed to satisfy a need of a domestic cat which is different from at least one other region. In the embodiment shown in figures, four distinct regions are illustrated. However, the present invention, in its broadest iteration, need only have a minimum of two such regions while the number of regions can increase to any level while remaining within the spirit of the present invention.

As noted, the principle characteristic of the present invention is that a plurality of distinct regions are provided each to satisfy a need of a domestic cat whereas different regions respond to different needs. In the illustration shown in FIG. 1, legion 11 is a plush surface promoting rest and relaxation of a cat Region 12 is carpet or sisal intended to act as a scratching surface Region 13 can also have a plush or scratching surface but, in this instance, closure 15 is provided whereby pouch 16 containing catnip can be inserted between the top and bottom layers of cat activity pad 10 in region 13. Closure 15 can be a zipper or hook and loop fasteners or any other appropriate closure device. Rounding out pad 10 is region 14 In this instance, a brittle crinkle material such as a Mylar® (polyethylene terephthalate) membrane is placed below surface 14 to create a crinkle feel and sound when walked upon by a cat. This gives a different sensory feel to the other surfaces described herein.

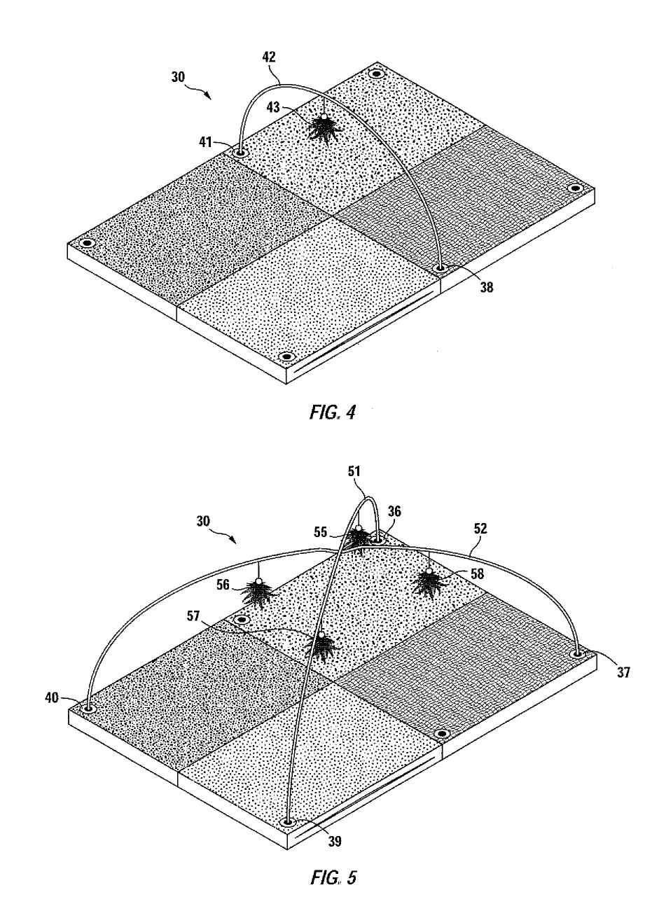

As a further preferred embodiment, reference is made to FIGS. 3, 4 and 5. Turning first to FIG. 3, cat activity pad 30 is provided with a plurality of receiving slots 36, 37, 38, 39, 40 and 41. As noted, these slots are generally positioned on the outer perimeter of cat activity pad 30. When not in use, cat activity pad 30 can function much like cat activity pad 10 as described above with reference to FIG. 1. However, they can be used to provide enhanced enjoyment to a cat by incorporating loop 42 (FIG. 4) whose ends are releasably inserted within receiving slots 38 and 41 causing loop 42 to extend over cat activity pad 30 as shown. Loop 42 can be any wire, plastic or wooden half circle generally being wrapped in a plush sleeve for safety and aesthetic appeal. Loop 42 can be used to suspend pet toy 43 above pet 30. It is envisioned that a cat lounging or otherwise influenced by catnip employing cat activity pad 30 would find it enjoyable to swat at pet toy 43 dangling overhead.

In that multiple receiving slots are provided about cat activity pad 30, a plurality of loops 51 and 52 can be employed, in the instance of FIG. 5, crossing over cat activity pad 30 by releasably engaging receiving slots 40 and 37 on the one hand and 36 and 39 on the other Support loops 51 and 52 can be employed to suspend pet toys 55, 56, 57 and 58 much as toy 43 was suspended from loop 42.

When shipping the present product from its manufacturing source or when storing the present invention in a retailer's facility, cat activity pad 10/30 can be folded or rolled upon itself to create a very compact geometry. Loops 42, 51 and 52 can be stacked alongside the cat activity pad to reduce shipping and warehousing costs. Catnip can be added as described above in pouch form after the cat activity pad has been laid out and the catnip pouch can be replaced as the catnip is exhausted.

What is claimed is:

1. A cat activity pad sized to accommodate a domestic cat, said pad comprising a plurality of distinct regions, each region designed to satisfy a need of said domestic cat different from at least one other region.

2. The cat activity pad of claim 1 wherein at least one of said regions comprises a closeable opening to receive catnip.

3. The cat activity pad of claim 1 wherein at least one of said regions comprises a cat scratching surface.

4. The cat activity pad of claim 1 wherein at least one of said regions comprises a plastic membrane to provide a crinkle feel and sound when walked upon by a cat.

5. The pet activity pad of claim 4 wherein said plastic membrane comprises polyethylene terephthalate

6. The pet activity pad of claim 1 wherein at least one of said regions comprises a plush surface.

7. The pet activity pad of claim 1 further comprising a plurality of receiving slots and at least one support loop sized to be releasably retained by said receiving slots such that said support loops extends over at least a portion of said pet activity pad.

8. The pet activity pad of claim 7 further comprising at least one support loop for supporting said pet toy above said pet activity pad.

9. The pet activity pad of claim 7 comprising two of said support loops crossing over one another above said pet activity pad.
